(19) United States
(12) Patent Application Publication
(10) Pub. No.: US 2014/0350736 A1
(43) Pub. Date: Nov. 27, 2014

(54) FLUID DENSITY VALVE ACCESS SYSTEM

(71) Applicants: Ronald Neal McMillan, Houston, TX (US); Terry Mike McMillan, Marietta, GA (US); Roger Dale Simmons, Madison, GA (US); Erich Alan Simmons, Dublin, OH (US)

(72) Inventors: Ronald Neal McMillan, Houston, TX (US); Terry Mike McMillan, Marietta, GA (US); Roger Dale Simmons, Madison, GA (US); Erich Alan Simmons, Dublin, OH (US)

(73) Assignee: REMOTE MONITORING SYSTEMS, LLC, Marietta, GA (US)

(21) Appl. No.: 13/960,939

(22) Filed: Aug. 7, 2013

Related U.S. Application Data
(60) Provisional application No. 61/827,125, filed on May 24, 2013.

(51) Int. Cl. B67D 7/32; G05D 7/06; B67D 7/08

(52) U.S. Cl. CPC B67D 7/3245; B67D 7/08; G05D 7/0676
USPC 700/282; 137/15.16

(57) ABSTRACT

A fluid density valve monitoring and access system secures the operation of an actuator that opens or closes a valve to a storage vessel, well or pipeline. The fluid density valve monitoring and access system includes a valve, an actuator, a mass flow meter, and a communication device that communicates with the valve actuator, the mass flow meter and an off-site secure website via the internet. The fluid density valve monitoring and access system has a mass flow meter that constantly monitors the fluid density of fluid passing through a valve either into or out of a storage vessel, well or pipeline. The fluid density valve monitoring and access system closes the valve whenever the fluid to be pumped through the valve has a density outside of an acceptable density range that has been programmed into the communication device. The monitoring system also notifies one or more persons whenever the valve is closed because the fluid has as density outside of an acceptable density range.

### STATEMENT OF RELATED APPLICATIONS

This application claims the benefit of U.S. Provisional Application No. 61/827,125 filed May 24, 2013 and entitled Security System for Water Disposal Wells.”

### BACKGROUND OF THE INVENTION

1. Field of the Invention

This invention relates to the field of monitoring the fluid density of fluid passing through a valve either into or out of a storage tank, well or pipeline. The monitoring system includes a mass flow meter that closes the valve whenever the fluid to be pumped through the valve has a density outside of an acceptable density range. The monitoring system also notifies one or more persons whenever the valve is closed because the fluid has a density outside of an acceptable density range.

2. Description of the Related Art

An oil well produces a mixture of oil, water, and gas. The mixture is pumped from the well through a pipe into a separator unit that is near the well site. At the separator unit (often referred to as a “gun barrel”), the oil, water, and gas from the well are separated.

The separated oil and water each flow through a separate network of piping to designated oil or water storage tanks. The separated gas flows through a separate piping network connected to a commercial pipeline and is ultimately sent to market. If no commercial pipeline is in place to handle the gas, it is either flared (burned at the site) or vented into the air.

The separation and storage of the oil and water typically take place at what is known in the industry a tank battery sites or tank batteries. Most water (usually salt water) is moved to salt water disposal wells by truck, since most oil production and the associated tank battery site are in remote areas where pipelines are not available.

In order for a tanker truck to remove the water from a tank at a site, the truck pulls up adjacent to the transfer pipe coming out of a crude oil tank, hooks up a flexible hose to the pipe, opens the mechanical valve that controls the flow of water from the pipe to the truck, and vacuums the water out of the water storage tank into the truck to then be taken to a salt water disposal well.

Salt water disposal well sites are normally unattended and located in remote areas. Some sites are commercial ventures that charge truckers $ 0.40-1.00 per barrel of water or perhaps $70-$100 per truckload for disposing of the water. Other salt water disposal well sites are owned by an oil production company and dumping is restricted to only those authorized by the company. Since many of the sites are not attended on a 24 hour-7 days a week basis and the valves are not locked or only locked with conventional locks (padlocks, etc.), there is little security' to prevent unauthorized dumping.

Unauthorized dumping is a serious problem for owners of the salt water disposal sites. Legitimate trucking companies that haul water tot disposal pay the owner of the salt water disposal well for each load dumped under a prearranged agreement. Legitimate trucking companies agree to only dump water taken from known producing oil well locations, so the disposal well owner knows what is being dumped into his well and has sonic comfort that the loads do riot contain high concentrations of mud, chemicals, concrete or other things that could damage his facility or create regulator issues for him.

Unauthorized dumping not only denies the dumping site's owner the revenue owed for the dumping, but an also seriously damage the pumps, piping, tanks, and even the well itself, if someone dumps illegal chemicals or concrete into the dump site. Thus, illegal dumping can cost the owner of the dump site hundreds of thousands of dollars in equipment repair or in environmental clean-up.

A need exists for a mom secure system or water disposal thereby hindering, it not completely preventing, the unauthorized dumping of water into disposal wells or other locations (e.g. tanks, surface storage facilities, and the like) and protecting the disposal facility (pumps, tanks, wells, etc.) from damage or contamination.

### SUMMARY OF THE INVENTION

The invention relates to a fluid density valve monitoring and access system that secures the operation of an actuator that opens or closes a valve to a storage vessel, well or pipeline. The fluid density valve monitoring and access system includes a valve, an actuator, a mass flow meter, and a communication device that communicates with the valve actuator, the mass now meter and an off-site secure website via the internet. The fluid density valve monitoring and access system has a mass flow meter that constantly monitors the fluid density of fluid passing through a valve either into or out of a storage vessel, well or pipeline. The fluid density valve monitoring and access system closes the valve whenever the fluid to be pumped through the valve has a density outside of an acceptable density range that has been programmed into the communication device. The monitoring system also notifies one or more persons whenever the valve is closed because the fluid has a density outside of an acceptable density range.

One embodiment of the present invention is a valve access system comprising: (a) a valve having an open position and a closed position, wherein the open position permits a fluid to flow through the valve and the closed position prevents flow through the valve; (b) an actuator for moving the valve to the open position or the closed position; (c) a mass flow meter that measures a fluid density of the fluid flowing through the valve; (d) a communication device located proximal to the valve, wherein the communication device is in communication with the actuator and the mass flow meter. and wherein the communication device is programmed to monitor the fluid density of the fluid flowing through the valve and to activate the actuator to close the valve if the fluid density falls outside of an authorized fluid density range: and (f) a secure web site remote from the communication device having a person designated to be notified if the valve is closed because the fluid passing through the valve is outside of the authorized fluid density range, wherein the web site is in communication with the communication device.

A second embodiment of the present invention is a valve access control system comprising: (a) a valve having an open position and a closed position, wherein the open position permits as fluid to flow through the valve and the closed position prevents flow through the valve; (b) an actuator for moving the valve to the open position or the closed position; (e) a mass flow meter that measures a fluid density of the fluid flowing through the valve; (d) a camera; (e) a control panel having an input device, a valve open signaling device in communication with the camera, and a valve close signaling device; (f) a communication control unit located proximal to the valve, wherein the communication control unit is in communication with the actuator, the mass flow meter, and the control panel; (g) a valve access program residing on the communication control unit, wherein the valve access program is programmed to monitor the fluid density of the fluid flowing through the valve and to activate, the actuator to close the valve if the fluid density falls outside of an authorized fluid density range; and (f) a secure web site remote from the communication control unit having an installed list, of personnel authorized for activating the actuator, at least one person designated to be notified if the valve is closed because the fluid density fell outside of the authorized fluid density range, and a historical database of all actuator activity, wherein the web site is in communication with the communication control unit.

Another embodiment of the present invention is a valve access control system comprising: (a) a valve having an open position and a closed position, wherein the open position permits a fluid to flow through the valve and the closed position prevents flow through the valve; (b) an actuator for moving the valve to the open position or the closed position; (c) a mass flow meter that measures a fluid density of the fluid flowing through the valve; (d) a strobe light that is activated whenever the actuator moves the valve to the open position and is inactivated whenever the actuator moves the valve to the closed position; (e) a camera; (f) a control panel having an input device with a keypad and a screen, a valve open signaling device that activates the valve actuator to open the valve, the camera to photograph a valve user that opens the valve, and a valve close signaling device that inactivates the camera; (g) a communication control unit located proximal to the valve having a first computer and an internet communication device, wherein the communication control unit is in communication with the actuator, the mass flow meter, and the control panel; (h) a valve access program residing on the first computer, wherein the valve access program is programmed to monitor the fluid density of the fluid flowing through the valve and to activate the actuator to close the valve if the fluid density falls outside of an authorized fluid density range; and (i) an information processing unit remote from the communication control unit, wherein the information processing unit maintains a list of personnel authorized to open a specific valve, a historical database of all activity related to the opening or closing of the valve, and in least one person designated to be notified if the valve is closed because the fluid density fell outside of the authorized fluid density range, wherein the information processing unit is in communication with the communication control unit.

Yet another embodiment of the present invention is a process for controlling the fluid density of a fluid sent through as valve, the process including the steps: (a) connecting an fluid transport truck hose to a first end of a pipe, wherein an opposed second end of the pipe is connected to a fluid storage area and wherein a fluid flowing through the pipe is controlled by an actuated valve having an open position that permits fluid flow through the valve into or out of the fluid storage area and a closed position that prevents fluid flow through the valve into or out of the storage area; (b) entering a valve user identifier into a valve control system that communicates information between a communication control unit at a valve site and an information processing unit remote from the valve site through a secure internet site; (c) entering a valve identification number for the actuated valve into the valve control system; (d) verifying that the valve user identifier is assigned to an authorized valve user for the actuated valve; (e) signaling the authorized valve user to activate a valve open signaling device that activates an actuator to open the valve and a camera to photograph the authorized valve user; (f) measuring a fluid density of the fluid sent through the valve; (g) recording a time when the valve was opened, the valve user identifier, and a photograph of the authorized user; (h) comparing the measured fluid density with an authorized fluid density range entered into the valve control system for the actuated valve; (i) closing the actuated valve if the measured fluid density falls outside the authorized fluid density for the actuated valve; and (j) notifying a person designated on a notification list whenever the valve is closed because the measured fluid density fell outside of the authorized fluid density for the actuated valve.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the, accompanying drawings, in which:

FIG. 1 is a general schematic of a first embodiment of a fluid density access system.

FIG. 2 is a general schematic of a second embodiment of a fluid density access system.

FIG. 3 is a frontal view of the control panel for the system shown in FIG. 2.

FIG. 4 is a schematic of the on-site communication control unit of the system shown in FIG. 2.

FIG. 5 is an illustration of the information in one embodiment of a Personnel List database.

FIG. 6 is an illustration of the information in one embodiment of an Authorization Group database.

FIG. 7 is an illustration of the information in one embodiment of a Notification Group database.

FIG. 8 is an illustration of the information in one embodiment of a Historical Database.

FIG. 9 is an illustration of the information in one embodiment of a valve status database for a specific valve.

### DESCRIPTION OF THE PREFERRED EMBODIMENTS

The monitoring system described herein relates to the field of controlling fluid access through as valve based on the density of the fluid passing through the valve. A fluid density valve monitoring and access system secures the operation of an actuator that opens or closes a valve to a storage vessel, well or pipeline. The fluid density valve monitoring and access system includes a valve, an actuator, a mass flow meter, and a communication device that commutates with the valve actuator, the mass flow meter and an off-site secure website via the internet. The fluid density valve monitoring and access system has a mass flow meter that constantly monitors the fluid density of fluid passing through a valve either into or out of a storage vessel, well or pipeline. The fluid density valve monitoring and access system closes the valve whenever the fluid to be pumped through the valve has a density outside of an acceptable density range that has been programmed into the communication device. The monitoring system also notifies one or more persons whenever the valve is closed because the fluid has a density outside of an acceptable density range.

### A First Embodiment of the Valve Access System

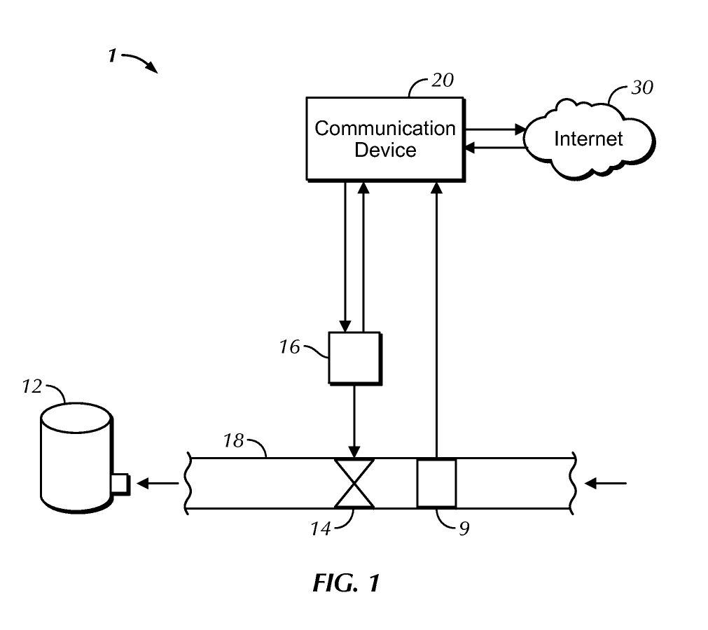

A first embodiment of a fluid density valve access system 1 is schematically illustrated in FIG. 1. The valve access system 1 has an on-site system having a valve 14, an actuator 16 as mass flow meter 9, and a communication device 5. The communication device 5 includes a data input means, such as a keyboard, a computer, and a connection means for connecting to and communicating with the internet 30.

One embodiment of the valve access system 1 has: (a) a valve 14 having an open position and a closed position, wherein the open position permits a thud to flow into or out of a storage vessel 12 and the closed position prevents flow into or out of the storage vessel 12; (b) an actuator 16 tot moving the valve to the open position or the closed position; (c) a mass flow meter 9, such as a Carioles flow meter; and (d) an on-site communication device 5 that communicates with the actuator 16, the mass flow meter 9, and a secure website through the internet 30.

The valve 14 is secured such that it can only be opened and closed by the actuator 16. When the valve 14 is in an open position, fluid flows through the pipe 18 between the storage tank 12 and a tank truck, pipeline, or other fluid reservoir and when the valve 14 is closed the fluid is not permitted to flow through the pipe 18. The valve 14 is typically a ball valve or a butterfly valve and the actuator 16 is generally an electric motor designed to open and close the valve 14.

A mass flow meter 9 is used to detect variations in the density of fluids hung pumped through the valve 14. A mass flow meter does not measure the volume per unit turn (e.g., cubic meters per second) of a fluid passing through a mass flow meter, instead it measures the mass per unit time (e.g., kilograms per second) flowing through the mass flow meter. Volumetric flow rate is the mass how rate divided by the fluid density.

Various designs of mass flow meters are available, but a preferred mass flow meter used in the fluid density valve access system 1 is the Coriolis meter. Its operation is based on the natural phenomenon called the Coriolis force, hence the name. Coriolis meters are true mass meters that measure the mass rate of flow directly as opposed to volumetric flow.

The communication device 5 includes software that is programmed to recognize a certain range of fluid densities for the fluid flowing through the mass flow meter 9. The communication device maintains communication with the mass flow meter 9 and whenever the fluid density strays outside of the predetermined acceptable density range programmed into the communication device 5, the communication device activates the actuator 16 to close the valve 14.

Whenever the valve 14 is opened and a liquid begins flowing through the mass flow meter 9 towards the valve, the mass flow meter begins measuring the density of the fluid in accordance with the setting in the software running on the communication device 5. If the density of the fluid falls outside the desired density range preprogrammed into the software of the communication device 5, the software sends a command to the actuator 16 that will immediately cause the actuator to close the valve 14. This process only takes a few seconds (perhaps 5-10 depending on the type of valve, the torque of the valve, and other factors). Thus, if the fluid density of the fluid pumped through the mass flow meter 9 falls outside the allowable density range, the rapid closure of the valve ensures that the disposal site equipment is not damaged.

Since unauthorized dumping of illegal chemicals or debris at storage tanks and well sites can cause tremendous damage to equipment, the communication device 5 is generally designed to communicate with a secure web site through the internet 30 to notify a designated person that the valve has been shut. Thus, each time the mass flow meter 9 closes the valve 14 because the fluid passing through the mass flow meter 9 is outside of the acceptable density range, the communication device communicates that information with the web site, which then notifies one or more persons to inform them that the valve has been shut off.

Optionally, the software on the communication device 5 will store all data associated with itch activation of the actuator 16. For example, the communication device software may maintain a historical database of valve/actuator activity that stores: (a) the time date, and security code used to open the valve 14; (b) the fluid density of the fluid pumped through the valve whenever the valve is opened: (c) the time and date when the valve was shut; (c) the time and date whenever a fluid density of a fluid passing through the mass flow meter 9 is outside of the acceptable density range programmed on the software of the communication device 5 for the valve 14; and (d) the time, date, and name of each person notified whenever the fluid density fell outside of the acceptable range.

The communication device 5 may also be programmed such that the actuator 16 cannot reopen the valve 14 after it has been shut due to the detection of an unacceptable fluid density event. The valve 14 could only he reopened after an authorized valve operator had gone to the site and checked the integrity of the mass flow meter, the valve, and cleaned out the system if needed. The operator would then have to manually reset the system.

### A Second Embodiment of the Valve Access System

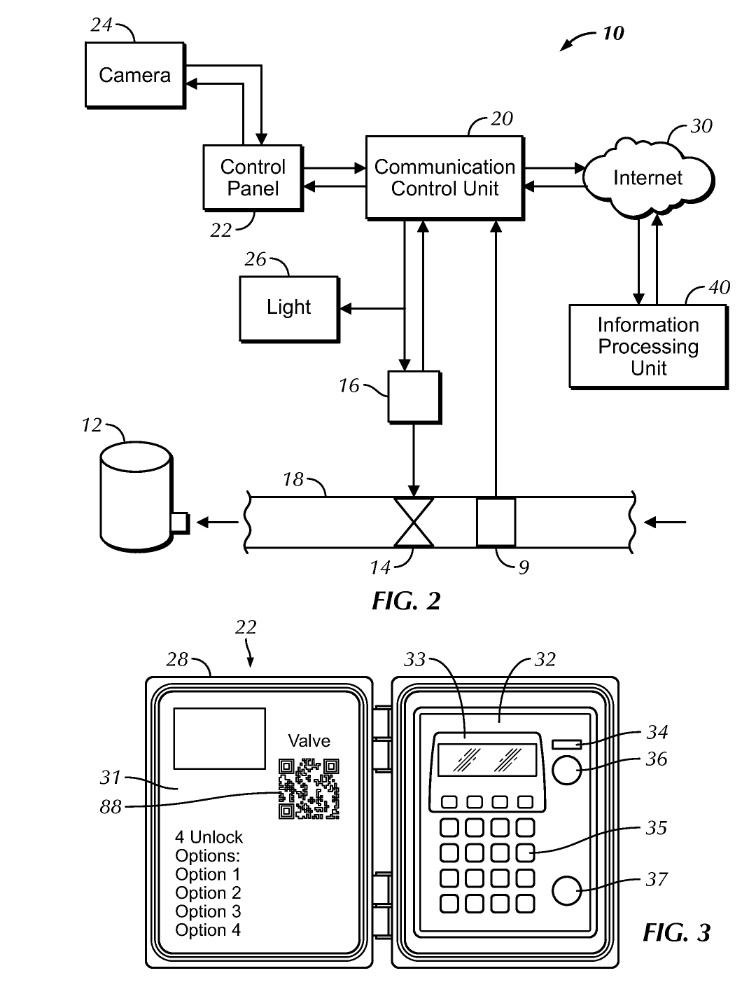

A second embodiment of the fluid density valve access system 10 is schematically illustrated in FIG. 2. The second embodiment of the fluid density valve access and monitoring system 10 has similar elements to the first embodiment of the fluid density valve access system 1, but has several added features.

A preferred embodiment of fluid density valve access system 10, illustrated in FIG. 2, includes: (a) a valve 14 having an open position and as closed position, wherein the open position permits a fluid to flow into or out of a storage vessel 12 and the closed position prevents flow into or out of the storage vessel 12; (b) an actuator 16 or moving the valve to the open position or the closed position; (c) a mass flow meter 9; (d) a strobe light; (e) a camera 24; (t) a control panel 22 having a key pad and an indicator device in communication with the actuator 16 and the camera 24; (g) an on-site communication control unit 20 that communicates with the control panel 22, the mass flow meter 9 and the actuator 16; and (h) an information processing unit 40 having an installed notification list of personnel to be notified whenever the actuator is actuated, wherein the information processing unit is in communication with the on-site communication control unit through a secure internet site 30.

The fluid density valve access system 10 has several of its components on-site where the valve 14 and the storage tank 12 are located. The on-site components include: the valve 14, the actuator 16, the camera 24, the strobe light 26, the mass flow meter 9, the control panel 22, and the communication control unit 20. The on-site system is coordinated and controlled by the communication control unit 20 described below.

The valve 14 is stewed such that it can only be opened and closed by an actuator 16. When the valve 14 is in an open position, fluid flows through the pipe 18 between the storage tank 12 and a tank truck, pipeline, or other fluid reservoir and when the valve 14 is closed the fluid is not permitted to lion through the pipe 18.

The system 10 optionally includes a strobe light 26 that is automatically turned on whenever the actuator 16 opens the valve 14. The activation of the strobe light 26 will alert anyone close by or on the site that a valve is open. Similarly, the strobe light is automatically shut off whenever the actuator 16 closes the valve 14.

The system 10 may also include a camera 24 that is automatically activated whenever a command to open the valve is received. Thus, as a valve user pushes an actuator “open” signaling device 36, the camera 24 takes a photo of the person activating the “open” signaling device, as well as a panoramic photo of the area in the general proximity of the valve 14. The camera 24 is preferably an infrared pan/tilt/zoom digital camera that automatically records all photos taken on the communication control unit 20.

An on-site control panel 22 contains control relays and communication hardware. One embodiment of the control panel 22 has input devices such as a keypad 32 and an open signaling device 36 and a shut signaling device 37 mounted in a housing with a hinged lid 28. Clearly mounted on the inside of the lid 28 are instructions 31 on how to open and shut the valve. The keypad 32 may be a touch screen keypad or the keypad 32 may have both a screen 33 and keys 35 for entering numbers, symbols or letters, such as shown in FIG. 3. Adjacent the keypad is an open indicator light 34 and/or the open signaling device 36, as well as the close signaling device 37. In some embodiments, the indicator light 34 and the open signaling device 36 are integrated. For example, the open signaling device 36 may be a clear elastomeric button having an indicator light 34 beneath it so that when the indicator light comes on the button is lit to indicate that the user must push it to activate the valve actuator 16 to open the valve 14.

A valve owner may have one or more valves at any particular site. If there is more than one valve located at a site, each valve is clearly labeled, with a valve identification number and each valve is assigned a specific valve open signaling device 36 and a specific valve close signaling device 37. Preferably each secured valve will have a mass flow meter 9 associated with that particular valve and its own access program On the CCU 20.

On-Site Communication Control Unit

The on-site communication control unit (CCU) 20 is the communication hub of system 10 and orchestrates the activation, deactivation, and cooperation of the various components of the system.

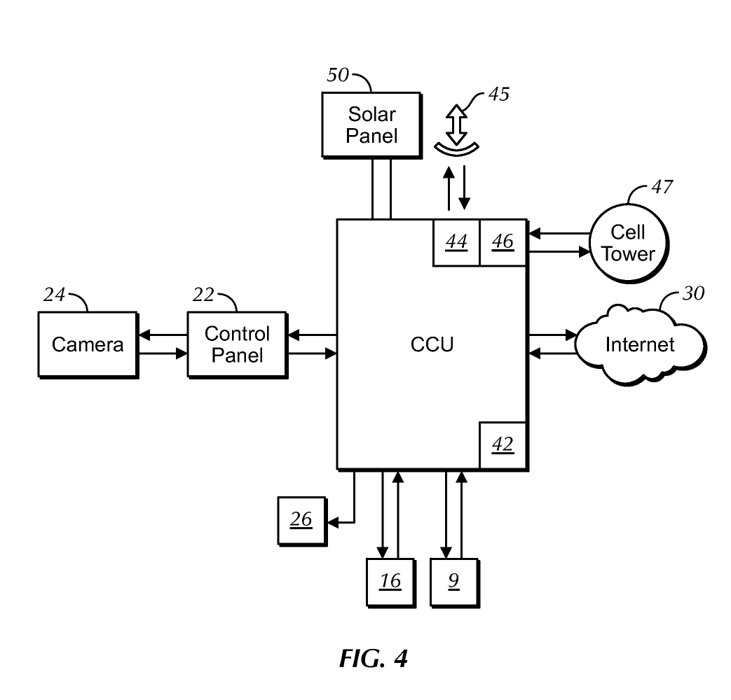

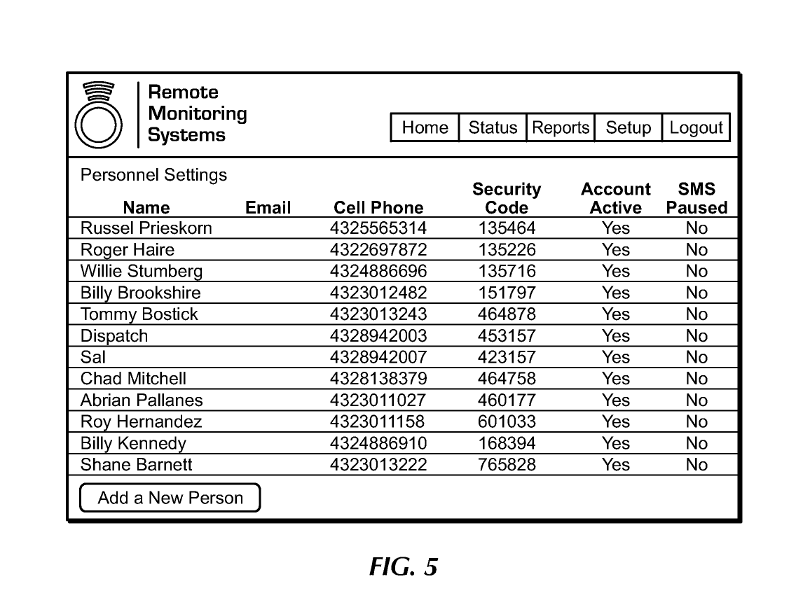

The on-site CCU, shown in FIG. 4, includes diversified communications equipment allowing the on-site CCU 20 to communicate with the mass flow meter 9, the actuator 16, a control panel 22, the light 26, the camera 24, and a secure off-site information processing unit (IPU) 40 via the internet 30. Preferably the on-site communication control unit 20 includes a computer, a router and one or more communication devices for connecting to the internet.

The software installed on the computer of the CCU 20 performs a number of functions and processes. Some of these functions and processes include the following: (a) receives and processes data entered from die keypad 32 at the control panel 22; (b) monitors the fluid density as determined by the mass flow meter 9; (c) activates the actuator 16 to open or close the valve 14; (d) activates the strobe light 26 and the camera 24 whenever the valve is opened; (e) stores all data associated with the opening or closing of the valve such as the time, date, name of the valve operator, photos of the valve operator and valve site, and fluid density as measured by the mass flow meter 9; and (f) connects to and communicates with the off-site IPU 40.

The communication control unit 20 typically includes at least one of the following communication devices: a modem 42 to allow the system to communicate via a “landline” internet connection (e.g., DSL or cable modem), a satellite antenna 44 to communicate via low orbit satellite 45 (e.g., Iridium, etc.) or geosynchronous satellite 45 (e.g. Hughes.Net, etc.), and/or a cellular antenna 46 to communicate via a cellular communication tower data connection 47. The CCU 20 is designed to establish and maintain communications with an information control unit 40 that verifies the authorization of the valve user and allows authorized valve users to activate the valve actuator 16 in conjunction with the strobe light 26 and the camera 24.

Another important function of the CCU 20 is to monitor the fluid density of the fluid hung sent through the valve as measured by the mass flow meter 9. If the fluid density strays outside of a predetermined density range programmed into the CCU 20, the CCU 20 activates the actuator 16 to close the valve 14 and notifies the web site which is programmed to notify certain individuals of the valve closure.

Off-Site Information Processing Unit

The off-site information processing unit (IPU) 40 typically includes a computer, a server, a router and one or more communication devices for connecting to the internet. The web based software integral to system operations is designed to establish and maintain communications between the communication control unit 20 and the information processing unit 40. For example, a secure website resides on the server of the ICU 40 that commutates with the software installed on CCU 20 and the software on the server and/or the computer of the IPU 40. The information processing unit 40 is the communication center that works through the communication control unit 20 to orchestrate the activation, deactivation, and cooperation of the various on-site and off-site components of the system 10.

Preferred embodiments of the information processing unit (IPU) 40 has several lists or databases created by the owner of the valve and stored on the server of the IPU 40. These lists include a personnel list, a list of authorized personnel for operating a particular valve, and as list of personnel to be notified under certain circumstances.

Typically, a first step required by the IPU software is the creation of a “Personnel List.” The Personnel List is a list of the names and cell phone numbers of those persons authorized to open/close the valve 14. The Personnel List also includes a random computer assigned security code that can be used on-site at the control panel to operate a valve. An example of a Personnel List is shown in FIG. 5. The Personnel List is maintained on the remote server that is part of the IPU 40 and accessed via an internet connection over a DSL, satellite, or cell phone connection.

The list of names, e-mails, security codes and cell phone numbers on the Personnel List serves as a reference list for at least two other lists or databases created by the valve owners that is stored on the server within the information processing unit (i.e., the “Authorization Group” and the “Notification Group”). The valve owner and/or any authorized administrator of the website can add or delete names and phone numbers to the Personnel List.

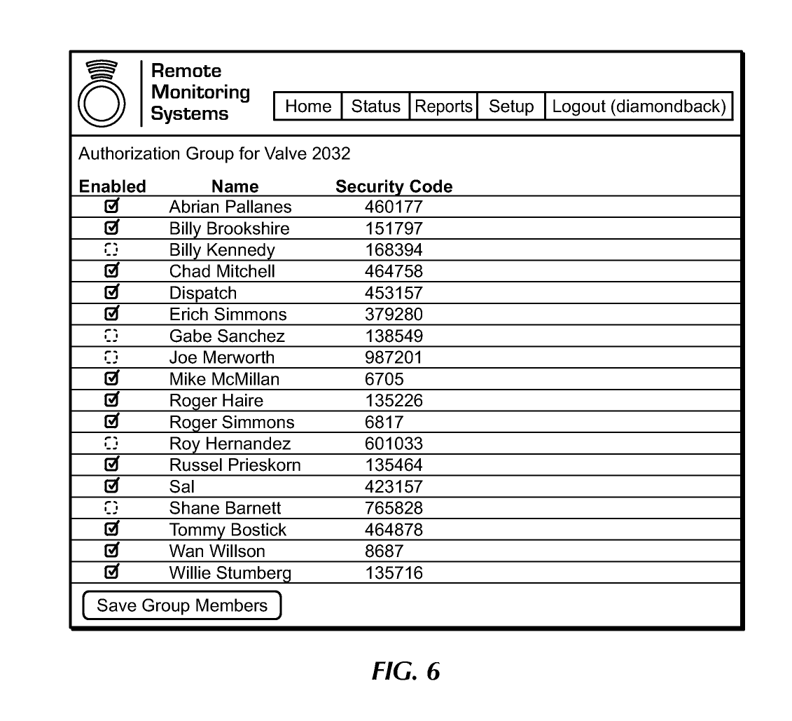

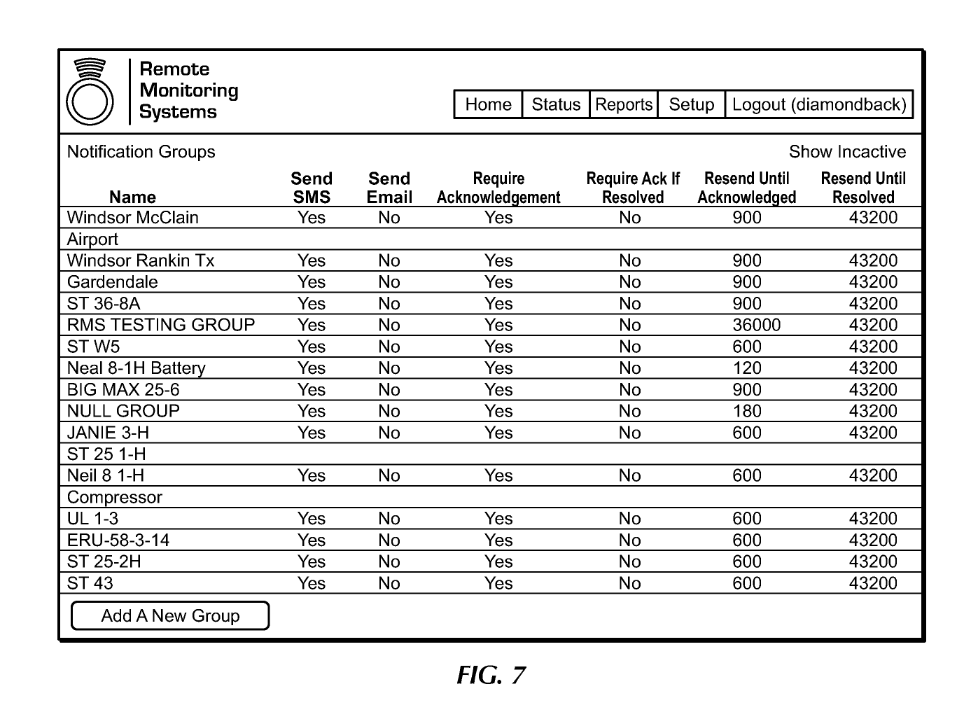

The Authorization Group (as shown in FIG. 6) designates which individuals on the Personnel List are authorized by the valve owner to open or close any individual valve (valves are numbered by location). By clicking on the “Enabled” box, the valve owner can give an individual access or deny access to a particular valve at a given site. The Authorization Group designates each person on the Personnel List that is authorized to open or close a particular valve, as well as an restrictions (time of day, day of week, fluid density, etc.) that may apply. The Authorization Group also includes the random computer assigned security code that can be used on-site to operate the valve.

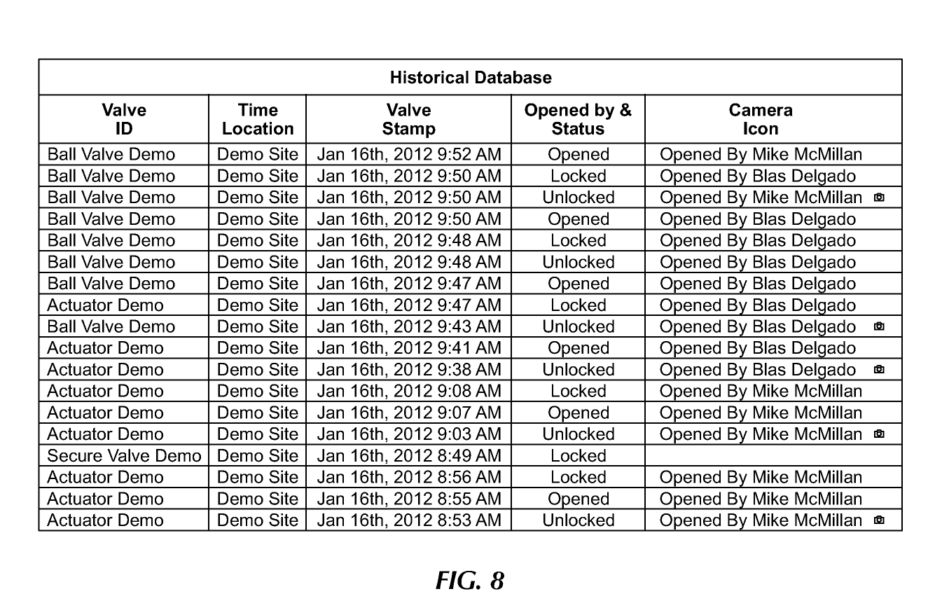

The owner of the valve may also create a Notification Group (illustrated in FIG. 7). The Notification Group is as list of names from the Personnel List designating which individuals are to be notified when a valve is opened or closed. The Notification Group may be customized for all valves at each location, for each valve at each location, or for different activities or events at specific valves. For example, one group of individuals may be notified whenever a specific valve is opened or closed for any reason. However, the Notification Group may include different individuals to be notified if the valve is closed because the fluid being sent through the valve has a density that is outside of an acceptable fluid density range for a particular storage tank or well.

The software allows each individual in the Notification Group to be notified either with a cellular telephone text message (indicated as a ‘yes’ or ‘no’ entry in the “Send SMS” column) or by e-mails (indicated as a ‘yes’ or ‘no’ entry in the “Send E-mail” column). Furthermore, the owner may require that any person notified whenever a valve is opened or closed actually acknowledge receipt of the notification (indicated as a ‘yes’ or ‘no’ in the “Require Acknowledgement” column). In addition, the software has the capability to send progressive alerts based on the valve owner or the valve administrator's preference as to who is to be notified first, second, third and so forth. The valve owner can also set the number of seconds that elapse before the next progressive alert notification is sent (“Resend Until Acknowledged” column) and how long (in seconds) the progressive alerts will be sent (“Resend Until Resolved” column).

One or more persons on the Notification Group list for a particular valve may also be required to acknowledge if a problem related to an event for which that person was notified has been resolved. One example of where this might be important is when a particular person is notified that a valve has been shut because the fluid being pumped through the valve fell outside of the authorized density range for that valve. In this situation it may be important for someone to go check the integrity of the mass flow meter 9 and the valve 14, as well as clean out any debris that might have been trapped within the pipe 18 before the valve 14 is placed back in service.

Monitoring Valve Access

Whenever a valve user requests clearance to open or close a specified valve, the Authorization Group is checked to ensure that the person making the request is indeed authorized to activate the actuator 16 to open or close that specific valve 14. Once the authorization of the person has been verified, an open indicator light 34 lights up and the person has a specific set time period (e.g., 20 seconds) to activate the open signal device 36 (e.g., push a button next to the open indicator light 34).

Once the authorized valve user activates the open signal device 36, the communication control unit 20 activates the actuator 16, the light 26 to illuminate the area around the valve, and the camera 24 to take a picture of the valve user and the general area around the valve (e.g., a truck unloading salt water at a salt water disposal well site). All photos are recorded in an onsite database in an industrial grade computer in the communication control unit 20, plus a copy of the photos are sent to the server off-site information processing unit 40 to be stored in a valve activity Historical Database that can be accessed by the owner of the valve.

The information processing unit server 40 also records the name of the person who opened or closed the valve (by cross referencing the security code entered to open the valve to the one assigned to each person listed in the Authorization Group), as well as records the time the valve was open and closed. The IPU server may also record the density of the fluid loaded or unloaded into the storage tank, well site or pipeline each time the valve was opened. All of the stored information, along with the corresponding photo of the person who opened the valve, is stored on the CCU 20 computer and in the IPU server's Historical Database. The Historical Database and any of the stored data are accessible at anytime from a computer or “smart phone.” FIG. 8 illustrates one example of a Historical Database recording the activation of one or more valves. Typically, the Historical Database is maintained by valve and location as set up by the valve users and/or website administrators.

To close the valve, the user needs only to press the close signaling device 37 on the control panel 22 and the valve 14 will immediately close. Once the valve 14 is closed the strobe light 26 goes off and the Historical Database is updated.

### Operation of the Fluid Density Valve Access System

The fluid density valve access systems 1 and 10 are designed to protect disposal sites from unauthorized dumping and to protect the storage tanks and well sites from contamination and damage due to the unauthorized addition or removal of fluids at remote sites. Unauthorized dumping is a particularly serious problem for owners of remote, unsecured salt water disposal wells. The dumping of illegal chemicals or concrete into the dump site can cause serious damage to the pumps, piping, tanks, and even the well itself. In such cases, the unauthorized dumping can cost the owner of the dump site hundreds of thousands of dollars for equipment repair or for environmental clean-up.

Operation of the First Embodiment of Fluid Density Valve Access System

Operation of the fluid density valve access system 1 of FIG. 1 allows the valve user to enter a security code into the communication device 5. If the security number is recognized by the communication device 5, then the valve user will be able to activate the actuator 16 to open the valve 14. Optionally, the software on the communication device 5 will date stamp the time that the valve was opened and store all data associated with each activation of the actuator 16 on the communication device 5 software program. For example, the communication device software may have a historical database that stores: (a) the time, date, and security code used to open the valve 14; (b) the fluid density of the fluid pumped through the valve whenever the valve is opened; (c) the time and date when the valve was shut; (c) the time and date whenever a fluid density of a fluid passing through the mass flow meter 9 is outside of the acceptable density range programmed on the software for valve 14; and (d) the time date, and name of each person notified whenever the fluid density fell outside of the acceptable range.

Once the salt-water or other liquid begins flowing through the valve 14, the mass flow meter 9 begins measuring the density of the fluid in accordance with the setting in the software running on the communication device 5. If the density of the fluid falls outside the desired density range preprogrammed into the software, the software on the communication device sends a command to the actuator 16 that immediately causes the actuator to close the valve 14. This process only takes a few seconds (perhaps 5-10 depending on the type of valve, the torque of the valve, and other factors). Thus, if the fluid density of the fluid pumped through the mass flow meter 9 falls outside the allowable density range, the rapid closure of the valve ensures that the disposal site equipment is not damaged.

Table 1 below lists the relative density by weight (in % heavier than water) of various materials that might be contained in a load being dumped at a salt-water disposal site that are heavier than water. Table 2 below lists the relative density by weight of various materials that might be contained in a load being dumped at a salt-water disposal site that are lighter than water (in lighter than water).

TABLE 1
Materials Having a Density Greater than Water

| | | | % Heavier |
|---|---|---|---|
| Material | Lbs./gallon | Lbs./cu. ft. | Than Water |
| Water | 8.34 | 62.4 | |
| Sea Water | 8.52 | 63.8 | 2.2% |
| Brine | 10.26 | 76.8 | 22.6% |
| Sand, Wet | 16.03 | 120.0 | 75.0% |
| Sand, Wet Packed | 17.36 | 130.0 | 56.3% |
| Sand, Dry | 13.36 | 100.0 | 28.9% |
| Sand, Loose | 12.03 | 90.0 | 27.6% |
| Sand, Water Filled | 16.03 | 120.0 | 64.0% |

TABLE 2
Materials Having a Density Lighter than Water

| | | | | % Lighter |
|---|---|---|---|---|
| Material | | Lbs./gallon | Lbs./cu. ft. | Than Water |
| Crude Oil | 48 API | 6.59 | 49.3 | −21.0% |
| Crude Oil | 40 API | 6.88 | 51.5 | −17.5% |
| Crude Oil | 35.6 API | 7.06 | 52.9 | −15.2% |
| Crude Oil | 32.6 API | 7.19 | 53.8 | −13.8% |
| Crude Oil | California | 7.63 | 57.1 | −8.5% |
| Crude Oil | Mexican | 8.11 | 60.7 | −2.7% |
| Crude Oil | Texas | 7.28 | 54.5 | −12.7% |

In setting up the s system 1, the owner of a salt water disposal site may assume, based on experience or testing, that the average truckload of authorized materials and liquids to be dumped at a particular site contains 99% brine and 0.5% oil. The site manager or owner then calculates that a density no greater than 8.52 lbs per gallon should pass into the disposal well. The software on the communication device 5 would then be programmed to trigger the activation of the valve actuator if the fluid density of the fluid passing through the Mass flow meter 9 is less than 8.0 lbs per gallon or greater than 9.0 lbs per gallon.

If someone manages to open the valve 14 and attempts to dump a load of material containing more sand or other heavy material (rock, concrete, etc.) than normal, the system software will read the density signals coming from the mass flow meter 9 as greater than 9.0 lbs per gallon and cause the valve to close as described above.

Whenever the valve is closed, either because the density of the material exceeded allowable safe level, or because, the valve user completed dumping his load, the software on the communication device 5 records the time when the valve closes in the activity database. The software on the communication device 5 typically communicates all valve activity to a secure website via the interact 30 to send an e-mail or text message to one or more designated persons.

Safety precautions may be programmed into the software, such that whenever the valve is closed because the density of the fluid passing, through the valve was less than 8.0 lbs per gallon or greater than 9.0 lbs per gallon, the valve is closed until a determination is made to override the closure or leave the valve closed until a service person visits the site and resets the valve actuator. The valve manager may access the data on the communication device 5 records through the internet 30 to determine the actual measurement of the thud density that closed the valve and who opened the valve to pump the fluid through the valve. The valve manager may then make a reasoned determination whether to reset the valve actuator through the internet communication with the communication device 5 or to send service personnel to the valve site to assess any damage and clean or repair the system.

Operation of he Second Embodiment of Fluid Density Valve Access System

The operation of the fluid density valve access system 10 of FIG. 2 is similar to system 1, but has more flexibility and security features as described below. For example, the owner or manager of the stilt-water disposal site, or other site where the valve is used, selects the method(s) by which the system 10 will recognize an individual that is authorized to open or close a particular valve. Five options that the owner or manager of the valve may select are described below.

Various authorization options allow an individual at the site to obtain authorization to activate the actuator 16 to open or close the valve 14 by performing one of the following, activities, (a) entering a previously assigned unique access code on the keypad 32 of the control panel 22, (b) scanning a QR code 88 posted on the control panel 22; (c) making a cell phone call to an access number posted at the site, (d) milking a cell phone all to a number posted at the site and using a text message to open the valve, or (e) calling a remote telephone number at an operations center or similar installation.

First Option. Probably the most direct way in which an on-site valve user can open the valve is to enter his random computer assigned security code on-site at the control panel 22. The user security code is assigned by the system software and recorded in the Personnel List and the Authorization Group database.

An industrial grade mini-computer (e.g. Raspberry Pi, etc.) in the communication control unit (CCU) 20 records the user security code and passes the information to the router and the modem that are also in the CCU 20. The modem in the CCU 20 will then establish communications via an Ethernet data connection to the remote information posing unit 40 via a DSL, cell phone, or satellite.

Once the communications path is established with the remote server at the IPU 40, the system software on the server will verify whether the entered security code matches a security code on the Personnel List and enabled in the Authorization Group database. If there is a match, the remote server will communicate through the established Ethernet data connection with the mini-computer in the communication control unit 20 at the remote valve site that access to open the valve 14 is granted. The software running on the mini-computer at the CCU 20 will then cause the display on the screen 33 of the control panel 22 to prompt the user to enter the valve identification number on the keypad 32.

Once the valve identification number is entered on control panel keypad, an open indicator light 34 on the control panel 22 next to the keypad 32 will begin to glow and a message on the keypad screen 33 will prompt the user to activate the open signaling device 36 within a specified time period. For example, the open signaling device may be a button or a switch that the user has 20 seconds to activate in order to open the valve 14. A preferred embodiment of the open signaling device 36 is a green control button on the control panel 22. Activating the open signaling device causes a relay to be energized in the communication control unit 20 to provide power to the actuator 16 and cause the valve 14 to open.

Simultaneously, when the relay in the CCU 20 closes, power is connected to the strobe light 26 causing it to start flashing. At the same time, the pan/tilt/zoom camera 24 is powered up and the software running on the mini-computer in the CCU 20 causes the camera to begin taking photos that are transmitted via the bard wiring back to the mini-computer. The software in the mini-computer temporarily stores the photos in its solid-state storage until the photos are transmitted via the Ethernet connection using the DSL, satellite, or cellular router/modem to the off-site server at the IPU 40. Typically, each CCU 20 is equipped with several transmitters/receivers such as a satellite and/or a cellular antenna.

The software running on the off-site server records the user photo, along with the name (e.g., a trucker) of the valve user who initiated the activation of the valve actuator 16. The photos correlated to the user name are time stamped and recorded in the Historical Database as depicted in FIG. 8. The server software also simultaneously accesses the Notification Group in the software running on the off-site server database to determine who is to be notified based on the valve owner's previously provided list. The server then sends e-mails or text messages to those cell phone numbers or e-mail addresses as designated in the Notification Group.

To close the valve 14, the valve user simply activates the close signaling device 37 (e.g., pressing a red button) on the control panel 22. Activating the close signaling device 37 causes a relay in the CCU 20 to once again power the actuator 16 causing the valve 14 to close. As soon as the relay contacts in the CCU 20 open, power is disconnected from the strobe light 26 causing it to stop flashing. At the same time, the power is disconnected to camera 24 and it discontinues taking photos.

The software running on the off-site server then records the time when the valve 14 closes in the Historical Database and again sends e-mails or text messages to the designated Notification Group maintained on the server notifying them that the valve has been closed.

Second Option: An on-site valve user can also use his “smart phone” to open the valve; provided that his cell phone number is registered with the owner of the valve and is entered in association with his name and security code on the Personnel List and the Authorization List. If the user's smart phone has a Quick Response (QR) scanner application on it, the user can use his phone to scan the QR code 88 posted on the control panel 22 to access the valve.

The computer in the communication control unit 20 will record the QR code scan and communicate the scan to the router and modem in the CCU 20 to be passed on to the off-site server. Thus, generally speaking once the user has scanned the QR code, the user is automatically connected to a secure web site stored on the Information Processing Unit 40. At that point the user will be prompted to hit the “send” button on his smart phone and then enter the valve number to be opened on his phone keyboard.

The system will then activate the open indicator light 34 and/or the open signaling device 36 on the nearby control panel 22. The user can then open the valve 14 by activating the open signaling device 36. From that point, the sequence of events in opening and closing the valve is the same as detailed above in the first option. With each opening or closing of the valve, the Notification Group is notified and the Historical Database is updated with information on who opened the valve, the time when the valve was opened, the time when the valve was closed, and the associated photographs from the site.

Third Option. An on-site valve user can also call a valve access number, which is connected to the remote server on the information processing unit 40. The software on the server will answer the call and cheek the Authorization Group database for the security code arid name associated with the cell phone number on the Personnel List. Upon verification that the calling cell phone number matches one on the Personnel List and that the individual identified with that cell phone number is included in the Authorization Group, the user will be prompted to enter the valve identification number on his cell phone keyboard. Once the valve identification number is entered, the software will prompt the user to activate the open signaling device 36 on the control panel 22 to open the valve 14.

From that point, the sequence of events in opening and closing: the valve is the same as detailed above in the first option. With each opening or closing of the valve, the Notification Group is notified and the Historical Database is updated with information on who opened the valve, the time when the valve was opened, the time when the valve was closed, and the associated photographs from the site.

Fourth Option. Similarly, an on-site valve user can use his cell phone to send a text message to the telephone number shown on the signage at the site to start the valve opening sequence. The user enters the posted telephone number on his phone and push “send.” The user will then be prompted to send a reply message that says “Lock/unlock valve #.” This message, including the proper valve identification number, automatically appear on the user's cell phone screen as part of the prompt.

When the user pushes “send” on his phone, the message will be sent. At this point the user will receive a message back prompting him to activate the open signaling device 36 on the control panel 22. The valve 14 opens as soon as the user activates the open signaling device 36.

From that point, the sequence of events in opening and closing the valve is the same as detailed above in the first option. With each opening or closing, of the valve, the Notification Group is notified and the Historical Database is updated with information on who opened the valve, the time when the valve was opened, the time when the valve was closed, and the associated photographs from the site.

Fifth Option. The owner of the valve to be opened can also open and/or close the valve 14 from a remote location such as an operations center. If this option is chosen, the user would he directed by signage at the site to call a telephone number for access. The operator at the remote location would then verify the identity of the person seeking to open the valve by cross-referencing the person's name, security code, or other information with the information registered on the Personnel List and in the Authorization Group as authorized to open the valve 14. The operator at the remote location can also activate the camera 24 at the site to view the person seeking valve access.

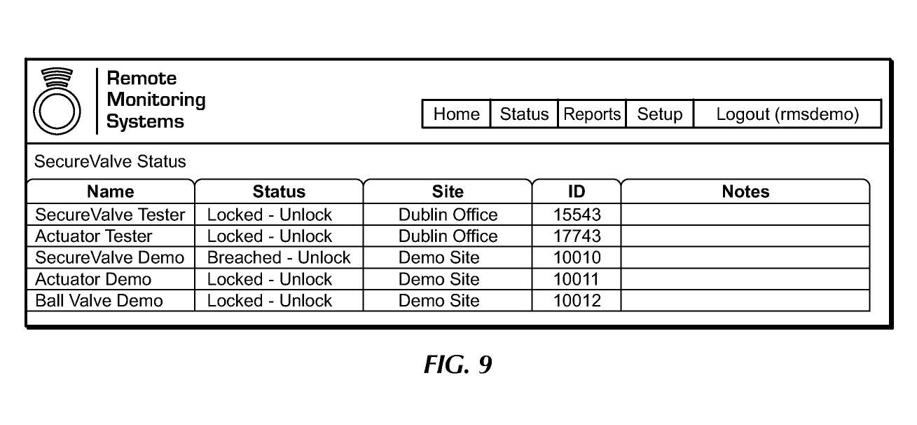

If the remote operator is satisfied that the person seeking access should be authorized to open the valve, the operator will access the system software Secure Valve Status screen seen in FIG. 9. The remote operator will then click on “Locked-Unlock” corresponding to the appropriate valve under the “Status” column to initiate the valve opening sequence and tell the person at the site to activate the open signaling device 36 on the control panel 22. As soon as the user activates the open signaling device 36, the valve 14 is opened.

From that point, the sequence of events in opening and closing the valve is the same as detailed above in the first option. With each opening or closing of the valve, the Historical Database is updated with information on who opened the valve, the time when the valve was opened, the time when the valve was closed, and the associated photographs from the site. The remote operator may also initiate the notification of the people on the Notification Group.

Once a valve is opened by an authorized valve operator, the salt-water or other liquid begins flowing through the pipe toward the valve 14. As the fluid begins passing through the mass flow meter 9, the mass flow meter begins measuring the density of the fluid as programmed by the software running on the CCU 20. If the density of the fluid falls outside the desired density range preprogrammed into the software, the software send a commands to the actuator 16 that immediately causes the actuator to close the valve 14. This process only takes a few seconds (perhaps 5-10 depending on the type of valve, the torque of the valve, and other factors). Thus, if the fluid density of the fluid pumped through the mass flow meter 9 fails outside the allowable density range, the rapid closure of the valve ensures that the disposal site equipment is not damaged.

The allowable density range of a valve is determined by the valve owner or manager as described above. If someone manages to open the valve 14 and attempts to dump a load of material containing more sand or other heavy material (rock, concrete, etc.) than normal, the system software will read the density signals coming from the mass flow meter 9 as greater than the allowed density range and cause the valve to close as described above.

Whenever the valve is closed, either because the density of the material exceeded the allowable safe level, or because the valve user completed dumping his load, the software on the CCU 20 records the time when the valve closes in the activity database. The software on the CCU 20 typically communicates all valve activity to a secure website to be recorded in the Historical Database. Each valve activity also triggers the IPU 40 to send an e-mail or text message to one or more designated persons in the Notification Group.

Specific safety precautions may be programmed into the software, such that whenever the valve is closed because the density of the fluid passing through the valve was outside of the authorized density range, the valve is closed until the person(s) within the Notification Group that are required to acknowledge that the valve closure due to fluid density has been resolved (see FIG. 7). Such person(s) may access the data recorded in the Historical Database or on die communication control unit 20 through the internet 30 to determine the actual measurement of the fluid density that closed the valve 14 and the mime and photograph of the per that opened the valve to pump the fluid through the valve. The person responsible for resolving the valve closure may then make a reasoned determination whether to reset the valve actuator through the internet communication with the CCU 20 or to send a service person to the valve site to assess any damage and clean or repair the system. Once the responsible person is assured that the valve closure has been resolved and the equipment, storage tank, well or pipeline integrity has been assured the person can then text or email the CCU 20 to acknowledge that the problem has been resolved. The system can then be reset for standard secured valve operation according to the fluid density valve access system 10.

The terms “comprising,” “including,” and “having” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the similar forms of words shall be taken to include the plural form of the same words, such that the terms mean that one or more of something is provided. For example, the phrase “a valve” should he read to describe one or more valves. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made in the preferred embodiments of the present invention without departing from its true spirit. The foregoing description is provided for the purpose of illustration only and should not be construed in a limiting sense. Only the language of the following claims should limit the scope of this invention.

What is claimed is:

1. A valve access control system comprising:
(a) a valve having an open position and a closed position, wherein the open position permits a fluid to fluky through the valve and the closed position pre vents flow through the valve;
(b) an actuator for moving the valve to the open position or the closed position;
(c) a mass flow meter that measures a fluid density of the fluid flowing through the valve;
(d) a communication device located proximal to the valve, wherein the communication device is in communication with the actuator and the mass flow meter, and wherein the communication device is programmed to monitor the fluid density of the fluid flowing through the valve and to activate the actuator to close the valve if the fluid density falls outside of an authorized fluid density range; and
(f) a secure web site remote from the communication device having a person designated to be notified if the valve is closed because the fluid passing through the valve is outside of the authorized fluid density range, wherein the web site is in communication with the communication device.

2. The valve access control system of claim 1, further comprising as camera that is activated whenever the actuator moves the valve to the open position.

3. The valve access control system of claim 2, wherein whenever the camera is activated the camera takes a photograph of the valve user and stores the photograph on the communication device.

4. The valve access control system of claim 2, wherein the camera infrared camera that can take both panoramic and close-up photographs.

5. A valve access control system comprising:
(a) a valve having an open position and a closed position, wherein the open position permits a fluid to flow through the valve and the closed position prevents flow through the valve;
(b) an actuator for moving the valve to the open position or the closed position;
(c) a mass flow meter that measures a fluid density of the fluid flowing through the value;
(d) a camera;
(e) a control panel having an input device, a valve open signaling device in communication with the camera, and a valve close signaling device;
(f) a communication control unit located proximal to the valve, wherein the communication control unit is in communication with the actuator, the mass flow meter, and the control panel;
(g) a valve access program residing on the communication control unit, wherein the valve access program is programmed to monitor the fluid density of the fluid flowing through the valve and to activate the actuator to close the valve if the fluid density falls outside of an authorized fluid density range; and
(f) a secure web site remote from the communication control unit having an installed list of personnel authorized for activating the actuator, at least one person designated to be notified if the valve is closed because the fluid density fell outside of the authorized fluid density range, and as historical database of all actuator activity, wherein the web site is in communication with the communication control unit.

6. The valve access control system of claim 5, further comprising a strobe light that is activated whenever the actuator moves the valve to the open position and is inactivated whenever the actuator moves the valve to the closed position.

7. The valve access control system of claim 5, wherein whenever a valve user activates the open signaling device the actuator moves the valve to the open position and activates the camera to take a photograph of the valve user.

8. The valve access control system of claim 5, wherein the communication control unit includes a computer, a router, and an internet communication device.

9. The valve access control system of claim 5, wherein the internet communication device is a modem, a satellite antenna, or a cellular antenna.

10. The valve access control system of claim 7, the photograph of the valve user is recorded in the historical database along, with a time the valve was opened.

11. The valve access control system of claim 5, wherein whenever the valve moves to the closed position, the camera is deactivated and a time when the valve was closed is recorded in the historical database.

12. The valve access control system of claim 5, wherein whenever the valve is opened the fluid density of the fluid flowing through the valve is recorded in the historical database.

13. A valve access control system comprising:
(a) a valve having an open position and a closed position, wherein the open position permits a fluid to flow through the valve and the closed position prevents flow through the valve;
(b) an actuator for moving the valve to the open position or the closed position;
(c) a mass flow meter that measures a fluid density of the fluid flowing through the valve;
(d) a strobe light that is activated whenever the actuator moves the valve to the open position and is inactivated whenever the actuator moves the valve to the closed position;
(e) a camera;
(f) a control panel having an input device with a keypad and a screen, a valve open signaling device that activates the valve actuator to open the valve, the camera to photograph a valve user that opens the valve, and a valve close signaling device that inactivates the camera;
(g) a communication control unit located proximal to the valve having a first computer and an interact communication device, wherein the communication control unit is in communication with the actuator, the mass flow meter, and the control panel;
(h) a valve access program residing on the first computer, wherein the valve access program is programmed to monitor the fluid density of the fluid flowing through the valve and to activate the actuator to close the valve if the fluid density falls outside of an authorized fluid density range; and
(i) an information processing unit remote from the communication control unit, wherein the information processing unit maintains a list of personnel authorized to open a specific valve, a historical database of all activity related to the opening or closing of the valve, and at least one person designated to be notified if the valve is closed because the fluid density fell outside of the authorized fluid density range, wherein the information processing unit is in communication with the communication control unit.

14. The valve access control system of claim 13, wherein the information processing unit as phone number and a computer assigned security code associated with each person listed as authorized to open a specific valve.

15. The valve access control system of claim 13, wherein the historical database records a time that the valve was opened, a time that the valve was closed, the name and photograph of the valve user, and the fluid density of the fluid sent to the valve.

16. The valve access control system of claim 13, wherein the camera is an infrared camera that can take both panoramic and close-up photographs.

17. The valve access control system of claim 13, wherein the internet communication device is a modem, a satellite antenna, or a cellular antenna.

18. The valve access control system of claim 13, wherein the information processing unit maintains a list of personnel to be notified whenever the valve is opened or closed.

19. A process for controlling the fluid density of a fluid sent through a valve, the process including the steps:
(a) connecting an fluid transport truck hose to a flit end of a pipe, wherein an opposed second end of the pipe is connected to a fluid storage area and wherein a fluid flowing through the pipe is controlled by an actuated valve having an open position that permits fluid flow through the valve into or out of the fluid storage area and a closed position that prevents fluid flow through the valve into or out of the storage area;
(b) entering a valve user identifier into a valve control system that communicates information between a communication control unit at a valve site and an information processing unit remote from the valve site through a secure interact site;
(c) entering a valve identification number for the actuated valve into the valve control system;
(d) verifying that the valve user identifier is assigned to an authorized valve user for the actuated valve;
(e) signaling the authorized valve user to activate a valve open signaling device that activates an actuator to open the valve and a camera to photograph the authorized valve user;
(f) measuring a fluid density of the fluid sent through the valve;
(g) recording a time when the valve: was opened, the valve user identifier, and a photograph of the authorized user;
(h) comparing the measured fluid density with an authorized fluid density range entered into the valve control system for the actuated valve;
(i) closing the actuated valve if the measured fluid density falls outside the authorized fluid density for the actuated valve; and
(j) notifying a person designated on a notification list whenever the valve is closed because the measured fluid density fell outside of the authorized fluid density for the actuated valve.

20. The process for controlling the fluid density of a fluid sent through a valve of claim 19, wherein the valve user identifier is a cellular phone number or a random computer generated security code.

21. The process for controlling the fluid density of a fluid sent through a valve of claim 19, further comprising the step of requiring the person designated on the notification list to acknowledge receipt of the notification of the valve closure because the measured fluid density fell outside of the authorized fluid density for the actuated valve.
